(19) United States
(12) Patent Application Publication
(10) Pub. No.: US 2017/0278105 A1
(43) Pub. Date: Sep. 28, 2017

(54) Method and System for Secure Handling of Electronic Financial Transactions

(71) Applicant: Claudia von Heesen, Wiesbaden (DE)

(72) Inventors: Claudia von Heesen, Wiesbaden (DE); Harald Spiegel, Wiesbaden (DE)

(21) Appl. No.: 15/619,447

(22) Filed: Jun. 10, 2017

Related U.S. Application Data
(62) Division of application No. 11/858,304, filed on Sep. 20, 2007.
(60) Provisional application No. 60/846,446, filed on Sep. 21, 2006.

(30) Foreign Application Priority Data
Oct. 13, 2006 (AT) GM747/2006

(51) Int. Cl. G06Q 20/40; G06Q 20/38; G06Q 20/36; G06Q 20/02

(52) U.S. Cl. CPC G06Q 20/40; G06Q 20/367; G06Q 20/02; G06Q 20/3674; G06Q 20/023; G06Q 20/382

(57) ABSTRACT

A method of exchanging, handling and controlling electronic financial services, particularly mobile electronic financial services from various financial services providers to authorized employs a wide variety of communication devices (both stationary and mobile). The system provides for the exchange of electronic financial services in the form of a standardized platform by means of corresponding interfaces irrespective of the way in which the individual transaction handling systems are linked to the electronic financial services exchanger. The financial services exchanger permits flexible linking of differing communication devices as well as various transaction handling systems from a variety of different financial services providers. For each financial transaction the electronic financial services exchanger generates a token which is communicated to the transaction initiator, received by the other user by an intentional transaction and returned as confirmation to the electronic financial services exchanger.

### CROSS REFERENCE TO RELATED APPLICATIONS

This application is a divisional application of U.S. Ser. No. 11/858,304 filed on Sep. 20, 2007. This application claims the priority of the U.S. provisional application 60/846,446 filed on Sep. 21, 2006, and of the Austrian utility model application AT GM 747/2006 filed on Oct. 13, 2006, these applications are incorporated by reference herein in their entirety.

### BACKGROUND

In the field of electronic financial services, especially electronic payment services and more particularly mobile electronic payment services a plurality of different systems are currently in use which are hardly, or not at all, intercompatible, the greatly different stationary and mobile communication devices of which communicate via proprietary protocols with proprietary mainframe computers of the financial services providers.

Current mobile electronic payment systems greatly depend on the communication device used, the selected mobile wireless network operator as well as on the financial services provider.

This situation is a serious obstacle to making use of mobile payment systems in full scope and thus cost-effectively.

In addition, the systems in use in the marketplace to date are based on a direct connection between the terminals or mobile communication devices of the payment partners.

In this arrangement, for each payment transaction security relevant or confidential information (for example bank account data of the payer and/or of the payee, the mobile communications number of the payer and/or of the payee etc.) is disclosed to the corresponding partner or communicated between the payment partners.

User authentication in established mobile payment systems is as a rule via a subscriber ID module (SIM) card of the mobile telephone and is thus dedicated to the device.

The established systems thus harbor the risk of being inherently open to misuse when the mobile telephone is stolen, with the risk of eavesdropping in the communication of user and invoice data from one mobile telephone to another with no possibility of anonymous payment.

Furthermore, established systems, especially on payment from one mobile communication device to another (peer-to-peer payment) necessitate a uniform access convention, i.e. it not being possible that the payee initializes the payment transaction via an online connection (e.g. with a wireless application protocol [WAP] browser) whilst the payer concludes payment by a text message such as a short message service (SMS) message.

Laid-open document DE 100 28 238 A1 describes a securities trading system on the basis of portable devices in which trading the securities is possible from security trading locations connected to the system via a uniform trading communications protocol and the trading transactions are performed by the connected security trading subsystems. The system as described is not conceived as an open non- earmarked payment system.

Laid-open document US 2001/0037264 describes a method and a system which in making use of the existing infrastructure of mobile wireless network operators enables customers by mobile wireless telephone to select, order and pay for merchandize in an online shop from a catalog by charging the amount to the mobile wireless account.

It is characteristic of the method that it is tied to a special mobile wireless operator or mobile wireless operator association, i.e. users not signed with this particular mobile wireless operator cannot use the system.

Described in laid-open document WO 98/47116 A1 is a method for performing payments from a customer to a merchant by telecommunication means as well as a corresponding device for performing the method. In this method the customer in the role as payer initiates payment by communicating by means of his mobile wireless telephone at least one merchant ID and the amount to be paid to a so-called telepay means which can connect to the bank of the customer, the bank of the merchant and to the merchant himself. The telepay means sends, among other things, the corresponding confirmation of receipt to the merchant. After having received the confirmation message from the merchant, the telepay means credits the merchant account and debits the customer account.

Characteristic of this method is that the payer initiates payment and is responsible for ensuring correct entry of the payment data with no error. Furthermore, use of this method is dedicated to one particular mobile telephone, since to authenticate payment use is made of data stored on the SIM card of the mobile telephone for ID and authentication.

DE 10 2004 041356 A1 of the same inventors as in the present invention and published on 13 Apr. 2006 and granted on 7 Dec. 2006 already discloses a method for secure handling of electronic financial services with features similar to those of the present application and a corresponding system for employing said method. The method comprises assigning each user to an electronic financial services exchanger using communication devices by the users entering a dedicated ID code and a secret code or other characteristic information of that user into communication devices for communication to the electronic financial services exchanger
authenticating the said users using the secret or characteristic information of users saved in the electronic financial services exchanger by the electronic financial services exchanger comparing the communicated assignment data of the users to the secret information saved in the electronic financial services exchanger,
initiating a financial service transaction by the transaction initiator,
entering the transaction parameters in a communication device by either party,
secure communication of the transaction parameters to the electronic financial services exchanger by said communication device,
allocating a transaction number representing the initiated financial service transaction and the data thereof by the electronic financial services exchanger,
communicating the transaction number to the communication device of the transaction initiator by the electronic financial services exchanger,
communicating the transaction number from the transaction initiator to the other user,
accepting the transaction number in the communication device of the other user,
communicating the transaction number together with the user ID from the other user to the electronic financial services exchanger by a communication device,
establishing the financial services providers associated with the transaction partners by the electronic financial services exchanger,
requesting the transaction handling systems to handle the transaction by the electronic financial services exchanger,
handling the transaction by the transaction handling systems using the financial accounts of the users,
evaluating the response messages from the transaction handling systems of the users by the electronic financial services exchanger, and
sending messages acknowledging handling of the transaction to the communication devices employed by the users by the electronic financial services exchanger.

The system of DE 10 2004 041356 comprises
an electronic financial services exchanger for central control of the complete method, comprising
a user data storage for storing the data of all registered users, the financial account data to the accounts of the said users,
a services provider data storage for storing the data of financial services providers including the access data to the transaction handling systems,
at least one terminal for use by a user and connected via an interface to the electronic financial services exchanger,
at least one financial account associated with a first user and serviced by the financial services provider.
at least one transaction handling system assigned to a financial services provider for performing electronic transactions, preferably electronic crediting, on the financial account of the user and connected via an interface to the electronic financial services exchanger,
at least one terminal for use by a second user and connected via an interface to the electronic financial services exchanger,
at least one financial account associated with the first user and serviced by a financial services provider,
at least one transaction handling system assigned to a financial services provider for performing electronic transactions, preferably electronic debiting on a financial account of the second user and connected via an interface to the electronic financial services exchanger.

However, in the present invention, tokens are used where DE 3.0 2004 041356 A1 uses transaction numbers (TANs) and first and second communication devices are used by a first and a second user instead of terminals as used in DE 10 2004 041356.

Described in laid-open document WO 98/52151 is a method and a device for performing electronic transactions, particularly payments, using asymmetric encryption. In this method the transaction data is likewise entered solely by the customer and the transaction initiated. The customer has sole responsibility for forming the transaction message and communicating it by means of a digital signature generated by means of data stored on the SIM card of his mobile telephone. This transaction message is communicated to a banking means which checks the digital signature and prompts performance of the transaction. Using a digital signature permits communication of the transaction message over non-secure communication channels and verification that the transaction message has not been changed during communication.

With this method too, it is characteristic that solely the customer is responsible for entering the transaction data free of error and that the user is tied to one particular mobile telephone.

Described in German patent DE 199 03 822 C2 (of which an English language equivalent has been published as Canadian Patent Publication 2,361,489) is a method and a system for cashless payment. The merchant in the role of the payee starts the payment transaction by entering the payment data preferably at a stationary merchant station, particularly on his mobile telephone. From here the data together with the merchant ID is sent to a verification means. The verification means checks in making use of the data received by merchant station whether the merchant station is permitted to perform payment transactions and, if so, opens a payment transaction, the customer in the role of the payer confirms the opened payment transaction either by entering the ID of the merchant into his mobile telephone, receives it via an infrared connection from the merchant station and then communicates it together with the ID data to the verification means, or by communicating it via a voice connection to the verification means. When the confirmation sent by the customer matches an open payment transaction, the payment data is communicated to the mobile wireless telephone of the customer so that payment can be ultimately confirmed by the customer.

Characteristic of this method is that the merchant is responsible for entering the invoice data and payment data and the payment transaction is simpler for the customer. What is a disadvantage is that only one open payment transaction is allowed per merchant station as is inherent to the method, i.e. subsequent customers are forced to wait until the person beforehand has completed his payment transaction.

Point of sale direct debit systems currently in use require a payer to provide identification about himself and the intended source of funds (e.g. an account with a financial institution such as a bank) through a terminal (for example by “swiping” a direct debit card and entering a personal identification number (PIN) into a system in which such information is matched to information provided by the payee as to the value of the transaction and the amount is then debited against the payer's account with the financial institution associated with the information provided and credited to the payee's account.

However, current systems lack desirable flexibility both from the point of view of enabling the parties to choose the accounts that they wish to use for any transaction and having regard to the technical means used for participating in the transaction.

Furthermore current systems lack desirable security from the point of view of protecting the high security financial networks of any financial services providers (internal layer) against intrusions from the public user area (external layer) in a standardized way while providing a safety standard which guarantees an evenly high level of security throughout the total area covered by said network.

### SUMMARY

The problem underlying the present invention is to provide a method and a system for secure handling of electronic financial transactions which allow one to maintain a high level of security against unwanted intrusions from the public user area, provide a level of maximum security for the users against eavesdropping when performing transactions in the public user area and provide at the same time a very high degree of flexibility for the users when choosing means for handling financial transactions, preferably payment transactions.

In order to address these problems the present invention provides a dedicated system architecture which sets up an additional exchanging layer between the internal and the external layer which
encapsulates the internal layer from the point of view of the external layer and therefore
protects the internal layer against intrusions from the external layer and
provides a method and a system wherein at least two different communication interfaces and/or access methods are used for access of the communication devices of users to the exchanging layer, wherein different users may use identical or different communication interfaces and/or access methods for accessing the exchanging layer, and
provides a method and a system wherein at least one communication interface and/or access method is used for exchanging information between the internal layer and the exchanging layer.

The additional exchanging layer makes the structures within the internal and the external layer independent from each other. Changes within one layer have no impact on the other layer and vice versa.

### DETAILED DESCRIPTION

In particular the present application discloses a method and a system, which may be preferably implemented for handling financial service exchanges on a standardized open platform which show the following advantages over prior art systems (which have has only restricted usability) by demonstrating the two following “universality aspects”:

In a first general aspect (on the “internal layer”) the invention provides a financial services exchanger with a standardized platform wherein appropriate interfaces allow a connection of any kind of transaction handling system to said standardized platform, irrespective of the type of the transaction handling system and irrespective of the type of connection.

In a second general aspect (on the “external layer”) the electronic financial services exchanger makes it possible to logically link any type of terminal and to make use of any kind of dialogue protocol.

Thirdly, the sequence of token generation and exchange between transferee and (potential) transferor is such that any unauthorized use of a token by a third party will lead to the consequences that the financial accounts of said third party will be debited with the amount of money that should have been paid by the (potential) transferor, such making any kind of unauthorized use unattractive.

Accordingly, the present invention provides a method for secure handling of electronic financial transactions between users by using a computer-implemented system, said system comprising an exchanging layer between an internal layer dedicated to at least one financial services provider administering accounts and corresponding funds for said users and an external layer accessible to said users via communication devices, said internal layer being encapsulated by the exchanging layer and thus protected against the external layer,

said method comprising the steps of using a token representing parameters of an intended transaction between users in the roles of a potential transferee, such as a payee and a potential transferor, such as a payer, respectively, wherein said token is generated in the exchanging layer upon the request of the potential transferee and then communicated to the potential transferor who sends said token back to the exchanging layer together with information which identifies the potential transferor, whereupon said exchanging layer prompts a transfer of funds from accounts administered in the internal layer for the potential transferor to accounts administered in the internal layer for the potential transferee.

The invention further provides a computer implemented system for performing one or more of the methods for secure handling of electronic financial transactions between users,

said system comprising an exchanging layer between an internal layer dedicated to at least one financial services provider administering accounts and corresponding funds for said users and an external layer accessible to said users via communication devices, said internal layer being encapsulated by the exchanging layer and thus protected against the external layer,

wherein a token representing parameters of an intended transaction, between users in the roles of a potential transferee (for example a payee) and a potential transferor (for example a payer)
is to be generated in the exchanging layer upon the request of the potential transferee,
is to be communicated to the potential transferor and
is to be sent back to the exchanging layer together with information which identifies the potential transferor

whereupon said exchanging layer is to prompt a transfer of funds from accounts administered in the internal layer for the potential transferor to accounts administered in the internal layer for the potential transferee.

In the following and throughout the description and the claims the terms “transferor” and “transferee” are meant not to be strictly restricted to the meaning of “somebody transferring money or monetary funds to another person” as well the recipient of such monetary transfers. Rather the “transferor” and the “transferee” can be involved in any kind of transfer of benefits from one person (“payer”, “benefactor”, “sender”) to a recipient of such a transfer (“payee”, “beneficiary”, “receiver”) and any equivalents of goods or services, not only money or monetary funds, but also coupons, shares, etc. could be handled in a transaction between “transferor” and “transferee”.

Furthermore the present invention provides a financial exchange database or inter-connected databases (herein referred to as a financial services exchanger) in which the necessary data is stored to provide flexibility from either or both of these aspects. Such database or databases can be accessed in real time to permit a transaction to proceed.

Such database or databases will contain identifier information about subscribers to the system and from one aspect also contain information as to accounts with financial institutions that may be involved in transactions that may be carried out using information contained in the database or databases.

Alternatively or additionally they may contain information as to the technical interfaces that may be used to communicate with parties who are subscribers to the system and have their details entered into the database or databases.

Said financial services exchanger may store data in any convenient form in which it may be accessed automatically in real time including, for example, by electrical, magnetic or optical methods. For example, the financial services exchanger may comprise a server in a computerized system.

User access to a system comprising said financial services exchanger may be by any convenient means permitting real time communication. Suitable communication devices for this purpose include personal computers, land-line based telephones, mobile telephones and other wireless communication devices and other fixed or mobile terminals. Such communication devices may be equipped with means for authenticating users employing the system which may be compared with user information stored in the financial services exchanger for the purposes of authenticating the identity of the user.

From another aspect, the present invention provides a mobile payment system for operation in full scope and thus cost-effectively must, among other things:
offer as many means of combination as possible for the communication devices used,
permit integrating as many electronic payment systems as possible already in successful operation to achieve cost-effective and speedy implementation,
permit use of existing current, cash card and credit card accounts of users to attain high acceptance,
permit as a platform as many different means of access (HTML, WAP, SMS, voice etc.) as possible without requiring the basic financial service process to be adapted,
be independent of the selected mobile wireless operator of the user
permit user authentication irrespective of the hardware involved and
be immune to interference.

The invention may be used to define a method for communicating electronic financial services of diverse financial services providers to authorized users with all sorts of communication devices (both stationary and mobile) and to control handling thereof.

In another aspect, the invention provides a method for secure handling of electronic financial services by means of:
an electronic financial services exchanger, a communication device associated with a first user in the role of the transaction initiator, preferably the transferee, connected by an interface to the electronic financial services exchanger,
a communication device associated with a second user in the role of the transaction handler, preferably the transferor, connected by an interface to the electronic financial services exchanger;
at least one financial account associated with a first user serviced by at least one financial services provider
at least one financial account associated with a second user serviced by at least one financial services provider,
at least one transaction handling system associated with at least one financial services provider for accessing the financial accounts and of each of the users respectively comprising the steps
assigning each user to the electronic financial services exchanger using communication devices by the users entering a dedicated ID code and a secret code or other characteristic information of that user into communication devices for communication to the electronic financial services exchanger
authenticating the said users using the secret or characteristic information of users saved in the electronic financial services exchanger by the electronic financial services exchanger comparing the communicated assignment data of the users to the secret information saved in the electronic financial services exchanger,
initiating a financial service transaction by the transaction initiator,
entering the transaction parameters in a communication device by either party (typically, but not necessarily the transaction initiator),
secure communication of the transaction parameters to the electronic financial services exchanger by said communication device,
allocating a token representing the initiated financial service transaction and the data thereof by the electronic financial services exchanger,
communicating the token to the communication device of the transaction initiator by the electronic financial services exchanger,
communicating the token from the transaction initiator to the other user,
accepting the token in the communication device of the other user,
communicating the token together with the user ID from the other user to the electronic financial services exchanger by a communication device,
establishing the financial services providers associated with the transaction partners by the electronic financial services exchanger,
requesting the transaction handling systems to handle the transaction by the electronic financial services exchanger,
handling the transaction by the transaction handling systems using the financial accounts of the users,
evaluating the response messages from the transaction handling systems of the users by the electronic financial services exchanger,
sending messages acknowledging handling of the transaction to the communication devices employed by the users by the electronic financial services exchanger.

The financial services exchanger used in this method is desirably of the type noted above including a database or inter-active databases that contain identifier information about potential users of the method together with the necessary information about either or both of their financial account information that will be used in transactions to be carried out using the method and the electronic interface information as to how to contact users of the method electronically.

Useful ways of implementing the above described method include one wherein
the electronic financial services exchanger comprises a data storage for records of the transaction in which the records associated with a transaction are stored for the users,
after sending messages confirming handling of the transaction the following steps are additionally involved:
generating a duplicate record of the transaction for the transaction initiator by the electronic financial services exchanger,
storing the duplicate record of the transaction by the transaction data storage,
generating a duplicate record of the transaction for the other user by the electronic financial services exchanger,
storing the duplicate record of the transaction by the transaction data storage.

Useful ways for effecting data storage include inter alia hard drives, portable disks, semiconductor chips, holographic storages, magneto-optical memories, nanotubes, micro-electro-mechanical systems (MEMS), DNA storages.

In another useful method
at least one of the communication devices used comprises means for sensing biometric or other characteristic data of one or more of the users and communicating same either untouched or compressed to the electronic financial services exchanger,
at least one user entering a dedicated ID code in said communication devices and each communicating their biometric data to said communication device,
authentication of at least one of the users is done using secret information of the user saved in the electronic financial services exchanger by the electronic financial services exchanger comparing the communicated assignment data of at least one of the users to the biometric data

In yet another useful method tokens are transferred while holding the two communication devices, each of which comprises a short-range communication unit, close together.

In yet another method the second communication device is integrated in a vending machine.

In yet another method the vending machine directly displays the token(s).

In yet another method the vending machine displays or comprises a visual marker in a region which is sufficiently close to the second short range communication unit in order to allow the reception of the token by the first short range communication unit when the first communication device is held sufficiently close to the visual marker.

The invention further comprises a system that may be of use for implementing one or more of said methods.

In one aspect such a system comprises
an electronic financial services exchanger for central control of the complete method, comprising
a user data storage for storing the data of all registered users, the financial account data to the accounts of the said users,
a services provider data storage for storing the data of financial services providers including the access data to the transaction handling systems,
at least one communication device for use by a user and connected via an interface to the electronic financial services exchanger,
at least one financial account associated with a first user and serviced by the financial services provider,
at least one transaction handling system assigned to a financial services provider for performing electronic transactions, preferably electronic crediting, on the financial account of the user and connected via an interface to the electronic financial services exchanger,
at least one communication device for use by a second user and connected via an interface to the electronic financial services exchanger,
at least one financial account associated with the first user and serviced by a financial services provider,
at least one transaction handling system assigned to a financial services provider for performing electronic transactions, preferably electronic debiting on a financial account of the second user and connected via an interface to the electronic financial services exchanger.

Said system may additionally be of a type wherein at least one of the communication devices is a means of mobile telecommunication. In a further aspect, the electronic financial services exchanger may comprise a data storage for records of the transaction in which the record of the transaction associated with a transaction are stored for the users.

The system as described above may usefully provide sensors for sensing data characteristic of the user, for example biometric, behavioral characteristic or physiological characteristic data of the users and communicating same either untouched or compressed to the electronic financial services exchanger.

Such sensors may “read” any pertinent data such as biometric data such as fingerprints or retina or iris patterns or physiological data such as voice profiles. Sensors for such data are commercially available.

In another preferred embodiment each communication device comprises a short-range communication unit, respectively, for transferring tokens when holding the two communication devices sufficiently close together.

In yet another preferred embodiment the second communication device is integrated into a vending machine.

In yet another preferred embodiment the vending machine directly displays the token.

In yet another preferred embodiment the vending machine displays or comprises a visual marker in a region which is sufficiently close to the second short range communication unit in order to allow the reception of the token by the first short range communication unit when the first communication device is held sufficiently close to the visual marker.

In all the aforementioned embodiments it was implicitly assumed that both the first user in the role of a transferor and the second user in the role of a transferee are registered on a common hardware platform (“main server”) for the electronic financial services exchanger and that the processing of all transaction data pertaining to either the first user (transferor) or the second user (transferor) takes place on said common main server. This is the standard scenario for “ordinary” users who usually participate only in a relatively limited number of transactions within a given time limit.

However, in cases where a user (either transferor or transferee) participates in a very high number of transactions within a given time limit, for example in the case that a transferee is offering and selling articles and/or services via an internet based sales portal, the wish may arise, to have a dedicated server platform (“sub server”) which is under the physical and/or legal control of said user in order to assure the direct control of data and to increase the data security for said user. In such cases the registration and/or the processing of transactions of the transferee and/or transferor may be administered and/or handled on a sub server. In legal terms, such a user may have a “preferential licensee status” vis-a-vis the operator of the electronic financial services exchanger, whereas the above-mentioned “ordinary user” would have an “ordinary licensee status”.

### BRIEF DESCRIPTION OF THE DRAWINGS

FIG. 1 shows a first embodiment of a system architecture of a system according to the present invention.

FIGS. 2, 3 and 4 show a flow sequence of events in a first method according to the present invention employing a system according to FIG. 1.

FIG. 5 shows a second embodiment of a system architecture of a system according to the present invention.

FIG. 6 shows the beginning of a flow sequence of events in a second method according to the present invention employing a system according to FIG. 5.

FIGS. 7 and 8 show a third and a fourth embodiment of a system architecture of a system according to the present invention.

FIG. 9 shows an overview table of several combinatorial possibilities of sharing the registration rights for as well as the processing tasks of an electronic financial services exchanger used in a method according to the invention within a network of interconnected dedicated main and sub servers on which a first user (transferor) and a second user (transferee) are registered and on which processing of the steps of said method according to the invention takes place.

FIG. 10 schematically shows a specific set-up for combinations of dedicated main and sub servers in accordance with specific combinatorial possibilities displayed in FIG. 9, said specific setup being used for the registration of rights as well as the processing of tasks of an electronic financial services exchanger used in a method according to the invention.

### DETAILED DESCRIPTION OF THE PREFERRED EMBODIMENTS

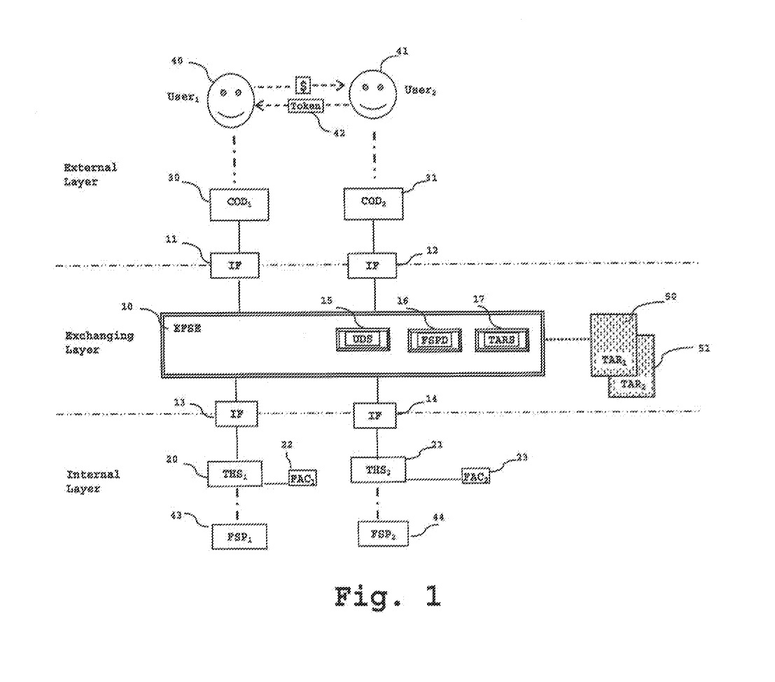

In the following explanation of the basic architecture of a system used for performing a method according to the invention, reference is made to FIG. 1, from bottom to top.

For communicating electronic financial services the system shown in FIG. 1 provides all services of the linked transaction handling systems 20, 21 from financial services providers 43, 44 in the form of a standardized platform. This is achieved by corresponding interfaces 13, 14 irrespective of the way in which the individual transaction handling systems 20, 21 are connected to a financial services exchanger 10.

Therein, linked transaction handling systems 20, 21 from financial services providers 43, 44 are hosted in an “internal layer”, the exact internal configuration of which is not of importance to users 40, 41 operating in an “external layer”.

Said “internal layer” and said “external layer” are separated from each other through an “exchanging layer” which encapsulates the internal layer and thus protects it from unauthorized access from the external layer. Communication between the various layers is effected through interfaces 11, 12 between the external layer and the exchanging layer and through interfaces 13, 14 between the exchanging layer and the internal layer.

Each service user 40, 41 makes connection via a communication device 30, 31, preferably a mobile wireless telephone, to the financial services exchanger 10, signs on and is able to prompt the wanted financial service. The financial services exchanger 10 identifies and authenticates at least one of the necessary financial services providers 43, 44, polls the needed data and coordinates the financial transactions associated with the financial service which are handled by the transaction handling systems 20, 21 of the financial services providers 43, 44 in making use of the financial accounts 22, 23.

The principle of the electronic financial services exchanger 10 now makes it possible to logically link the various communication devices 30, 31 as well as the diverse transaction handling systems 20, 21 to the various financial services providers 43, 44.

The exchange of confidential data as is critical to security is now no longer peer-to-peer, i.e. direct from communication device 30 to communication device 31 but, where at all possible, via standardized maximum security- communication links and the electronic financial services exchanger 10 in the sense of a platform.

The consequential use of tokens 42 as is novel in accordance with the invention now makes it possible to handle financial transactions, preferably payment transactions, without communicating or disclosing confidential data of the transaction partners.

The token principle is easy to display in mobile payment as the preferred means of transaction.

For example, the user 41 in the role of the transferee starts the payment transaction by communicating the record of the transaction data to the electronic financial services exchanger 10 via a secure standard communication link for example via HTML, WAP or SMS.

The electronic financial services exchanger 10 generates a token 42 and returns it to the user 41.

The generated token 42 represents the commenced payment transaction and the record of the transaction data contained therein, data as to the user 41 and as to his financial account 23, the financial services provider 44 as well as the transaction handling system 21 thereof.

The token 42 is totally uncritical for the user 41 and can thus be communicated as often as is required, preferably by it being displayed to the user 40 in the role of the transferor.

Since the token 42 comprises no large data volume, it can be communicated very simply and reliably.

No matter how the user 40 receives the token 42, it is not passed on to the electronic financial services exchanger 10 until as signaled by the user 40 in context with the user 41 as the transferee and declares the commenced transaction by the user 40 as the active transferor as legally binding by him entering the token 42 on his communication device 30.

The basic use of tokens in conjunction with a change in the communication medium now achieves maximum possible security in assuring that only the transaction partners actually involved, preferably payment partners, can take part in the transaction.

In addition to this, making use of transaction numbers now makes it possible that, for example, a transferee can initiate several payment transactions in parallel, since the individual transactions now remain separate by the dedicated tokens.

Beyond preventing sensible personal data of the users (e.g. identifying data of financial accounts, personal data, etc.) by using tokens encapsulating of the internal layer means at first to translate the different communication protocols and languages of the different transaction handling systems of the internal layer into one communication protocol. Secondly encapsulating of the internal layer means to present standardized financial services to the users 40, 41 of the external layer which will be mapped into the specific financial services of a specific transaction handling system when prompted by the exchanging layer.

In FIG. 1, user data storage 15 and services provider data storage 16 are provided, wherein data pertaining to both the users 40, 41, respectively, as well as to the financial services providers 43, 44, respectively, are memorized.

Furthermore, a transaction handling system 20 is provided which is responsible for checking whether for the transferor (user 40) a financial account 22 exists with an account ID (typically the account No.) stored in the user data storage 15 and whether the wanted payment transaction can be handled (typically by questioning coverage).

A transaction handling system 21 is also foreseen which is responsible for checking whether for the transferee (user 41) a financial account 23 with the account ID (typically the account No.) stored in the user data storage 15 exists and whether the wanted payment transaction can be handled.

Optionally, the financial services exchanger 10 can generate a duplicate record 51 of the transaction for the transferee (user 41) and a duplicate record 52 of the transaction 50 for the transferor (user 40) and may store both such records in a data storage 17.

### First Example Embodiment

With reference to the drawing as shown in FIGS. 1 to 4 a preferred example embodiment of the invention will now be detailed relating to mobile payment from a communication device 30 of a user 40 to a second communication device 31 of the user 41.

This example embodiment was selected because it is achievable directly with mobile wireless telephones as preferably currently available and thus the operator of such a system can count on relatively low starting costs.

Referring now to FIG. 1 there is illustrated the basic architecture of a computer-implemented system of the invention for performing one or more of the methods for secure handling of electronic financial transactions between users which comprises
an electronic financial services exchanger for central control of the complete method, comprising
a user data storage for storing the data of all registered users, the financial account data to the accounts of the said users,
a services provider data storage for storing the data of financial services providers including the access data to the transaction handling systems,
at least one communication device for use by a user and connected via an interface to the electronic financial services exchanger,
at least one financial account associated with a first user and serviced by the financial services provider,
at least one transaction handling system assigned to a financial services provider for performing electronic transactions, preferably electronic crediting, on the financial account of the user and connected via an interface to the electronic financial services exchanger,
at least one communication device for use by a second user and connected via an interface to the electronic financial services exchanger, at least one financial account associated with the first user and serviced by a financial services provider,
at least one transaction handling system assigned to a financial services provider for performing electronic transactions, preferably electronic debiting on a financial account of the second user and connected via an interface to the electronic financial services exchanger.

FIG. 1 further illustrates such a system wherein at least one of the communication devices is a means of mobile telecommunication.

Additionally FIG. 1 illustrates such a system wherein the electronic financial services exchanger comprises a data storage for records of the transaction in which records associated with a transaction are stored for the users.

FIG. 1 also illustrates such a system wherein sensors are provided for sensing data characteristic of the user, for example biometric, behavioral characteristic or physiological characteristic data of the users and communicating same either untouched or compressed to the electronic financial services exchanger and in particular one wherein sensors read any pertinent data such as biometric data such as fingerprints or retina or iris patterns or physiological data such as voice profiles.

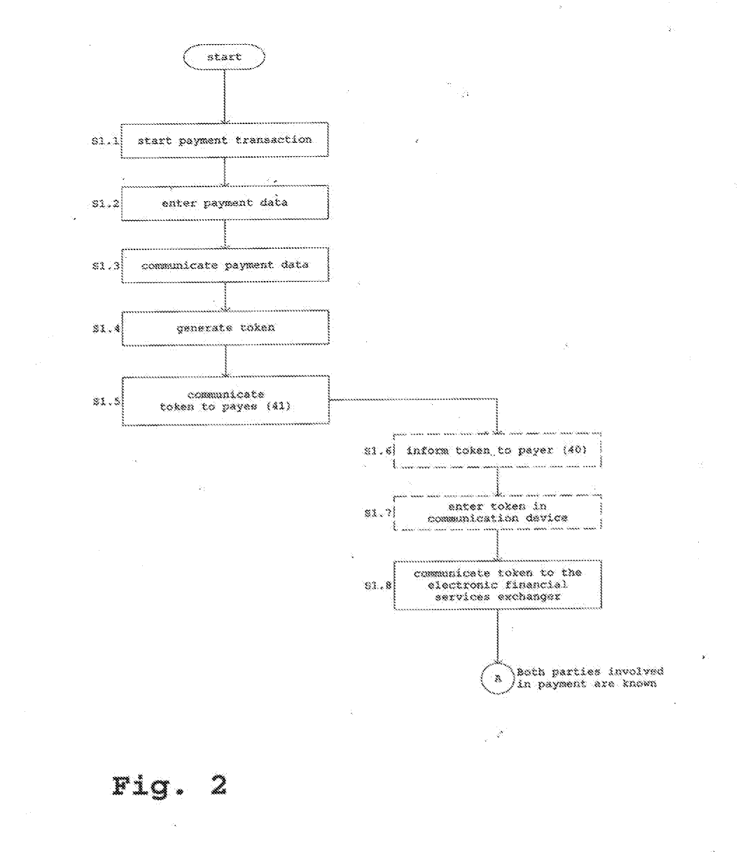

FIGS. 2, 3 and 4 illustrate the sequence of the method as follows: A method for secure handling of electronic financial transactions between users by using a computer-implemented system, wherein secure handling of electronic financial services is effected by means of:
an electronic financial services exchanger, a communication device associated with a first user in the role of the transaction initiator, connected by an interface to the electronic financial services exchanger,
a communication device associated with a second user in the role of the transaction handler, connected by an interface to the electronic financial services exchanger,
at least one financial account associated with a first user serviced by at least one financial services provider,
at least one financial account associated with a second user serviced by at least one financial services provider,
at least one transaction handling system associated with at least one financial services provider for accessing the financial accounts and of each of the users, respectively, comprising the steps
assigning each user to the electronic financial services exchanger sing communication devices by the users entering a dedicated ID code and a secret code or other characteristic information of that user into communication devices for communication to the electronic financial services exchanger
authenticating the said users using the secret or characteristic information of users saved in the electronic financial services exchanger by the electronic financial services exchanger comparing the communicated assignment data of the users to the secret information saved in the electronic financial services exchanger,
initiating a financial service transaction by the transaction initiator,
entering the transaction parameters in a communication device by either party,
secure communication of the transaction parameters to the electronic financial services exchanger by said communication device,
allocating a token representing the initiated financial service transaction and the data thereof by the electronic financial services exchanger,
communicating the token to the communication device of the transaction initiator by the electronic financial services exchanger,
communicating the token from the transaction initiator to the other user,
accepting the token in the communication device of the other user,
communicating the token together with the user ID from the other user to the electronic financial services exchanger by a communication device,
establishing the financial services providers associated with the transaction partners by the electronic financial services exchanger,
requesting the transaction handling systems to handle the transaction by the electronic financial services exchanger,
handling the transaction by the transaction handling systems using the financial accounts of the users,
evaluating the response messages from the transaction handling systems of the users by the electronic financial services exchanger,
sending messages acknowledging handling of the transaction to the communication devices employed by the users by the electronic financial services exchanger.

These Figures in particular illustrate a method of this type, wherein
the electronic financial services exchanger comprises a data storage for records of the transaction in which the records associated with a transaction are stored for the users,
after sending messages confirming handling of the transaction the following steps are additionally-involved:
generating a duplicate record of the transaction for the transaction initiator by the electronic financial services exchanger,
storing the duplicate record of the transaction by the transaction data storage,
generating a duplicate record of the transaction for the other user by the electronic financial services exchanger,
storing the duplicate record of the transaction by the transaction data storage.

They further illustrate a method of this type, wherein said data storage may comprise hard drives, portable disks, semiconductor chips, holographic storages, magnetooptical memories, nanotubes, micro-electro-mechanical systems (MEMS), DNA storages.

Additionally, these Figures illustrate a method of this type wherein
at least one of the communication devices used comprises means for sensing biometric or other characteristic data of one or more of the users and communicating same either untouched or compressed to the electronic financial services exchanger,
at least one user entering a dedicated ID code in said communication devices and each communicating their biometric data to said communication device, authentication of at least one of the users is done using secret information of the user saved in the electronic financial services exchanger by the electronic financial services exchanger comparing the communicated assignment data of at least one of the users to the biometric data saved in the electronic financial services exchanger.

The requirement for making use of the financial service in accordance with the method or system in accordance with the invention is that both the users 40, 41 as well as the financial services providers 43, 44 are memorized in the user data storage 15 and services provider data storage 16, respectively, and are registered with the electronic financial services exchanger 10.

When a user 40, 41 wishes to accept e.g. electronic credit cards he additionally requires the corresponding acceptance agreements with the corresponding credit or cash card institute.

The user 41 in the role of the transferee selects in step SI.I on his communication device 31 the function “receive payment” and then enters in step SI.2 the necessary data (preferably amount of payment, currency, VAT included /not included).

In step SI.3 the electronic financial services exchanger 10 receives the order for payment handling and in the preferred version of the method in step SI.4 generates for current mobile wireless telephones (status 08.2004) a token 42 which is displayed on the communication device 31 of the transferee (user 41) in step SI.5.

So that the financial services exchanger 10 can identify the transferor (user 40) the transferee (user 41) informs the transferor (user 40) in step SI.6 of the token 42 typically by voice, telephone, and particularly also in writing. The transferor (user 40) enters this token 42 into his communication device 30 (step SI.7). After communication of the token 42 to the electronic financial services exchanger 10 in step SI.8 the payment partners (users 40 and 41) are fully known to the financial services exchanger 10 (milestone A).

On the basis of the known payment partners (users 40 and 41) the financial services exchanger 10 in using the data stored in the user data storage 15 and services provider data storage 16 as well as the data entered by the transferor (user 40) establishes in step SI.9 and step SI.10 both the financial services provider 43 of the transferor (user 40) and the associated transaction handling system 20 as well as the financial services provider 44 of the transferee (user 41) and the associated transaction handling system 21.

In step SI.11 the financial services exchanger 10 sends a request to check the account to each of the transaction handling systems 20, 21 of the payment partners (users 40 and 41).

The transaction handling system 20 responsible for the transferor (user 40) checks in steps SI.12 and SI.14 whether a financial account 22 exists with the account ID (typically the account No.) stored in the user data storage 15 and whether the wanted payment transaction can be handled (typically by questioning coverage).

The transaction handling system 21 responsible for the transferee (user 41) checks in step SI.13 whether a financial account 23 with the account ID (typically the account No.) stored in the user data storage 15 exists and whether the wanted payment transaction can be handled.

As soon as the positive confirmations in checking the corresponding financial accounts 22, 23 have been received by the financial services exchanger 10 from the transaction handling systems 20, 21 (steps SI.15 and SI.16) the cash transfer transactions involved in the payment transaction are requested by the financial services exchanger 10 with the transaction handling systems 20, 21 (step SI.17)

Once all necessary cash transfer transactions have been successfully concluded and the corresponding concluding confirmations of the cash transfer have been received by the financial services exchanger 10 (steps SI.19 and SI.21) the financial services exchanger 10 sends confirmation of payment respectively to the communication device 30 of the transferor (user 40) and to the communication device 31 of the transferee (user 41) (steps SI.22 to SI.24).

If desired by the users 40, 41 the financial services exchanger 10 can generate a duplicate record of the transaction 51 for the transferee (user 41) in step SI.26 and a duplicate record of the transaction 50 for the transferor (user 40) in step SI.25 for storing in the record of the transaction in data storage 17. Both records of the transaction can be viewed at any time on a communication device via the financial services exchanger 10 by the respective record of the transaction owner (users 40 and 41).

### Second Example Embodiment

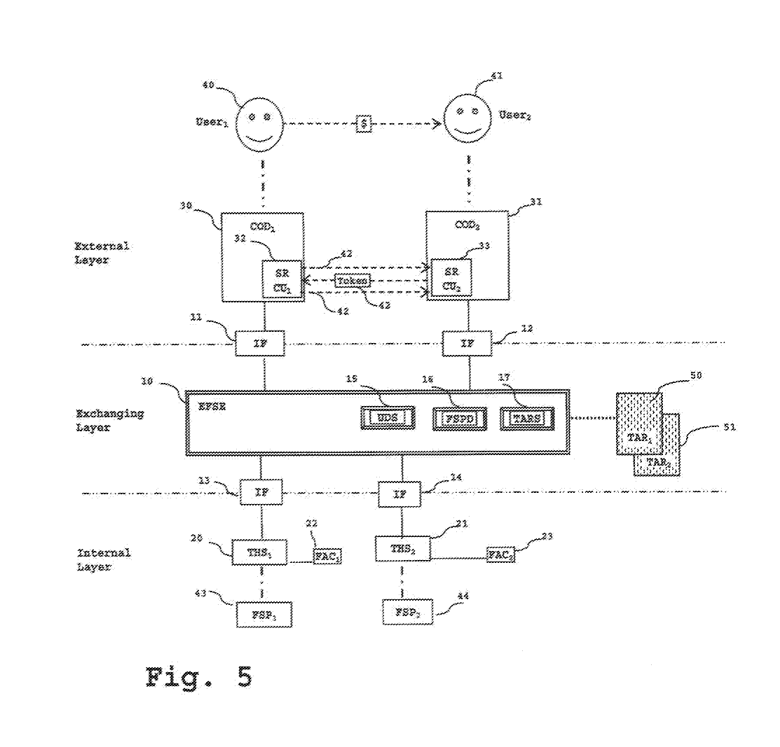

FIG. 5 shows a second embodiment of a system according to the invention based on the first embodiment shown in FIG. 1 but wherein the first communication device 30 comprises a first short range communication unit 32 and the second communication device 31 comprises a second short range communication unit 33.

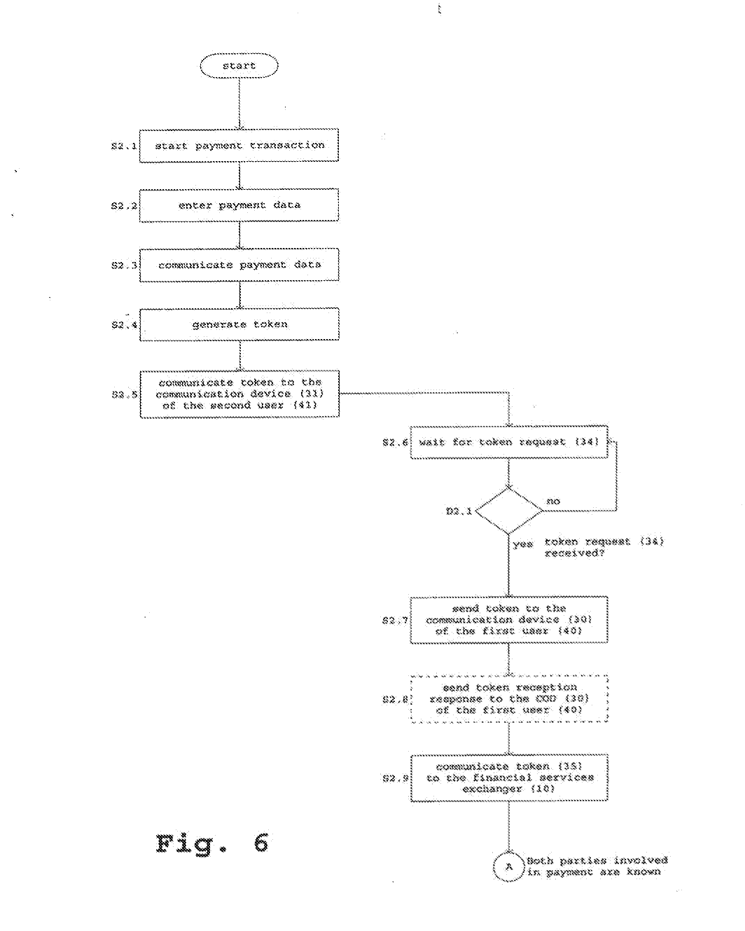

With reference to the drawings as shown in FIGS. 5 to 6 a preferred second example embodiment of the invention will now be detailed relating to mobile payment from a first communication device 30 of a first user 40 to a second communication device 31 of the second user 41 using said short range communication units 32, 33.

The two short range communication units cannot communicate with each other until they are put together in a close distance to each other, typically on the order of not more than 5 cm.

Referring now to FIG. 5 there is illustrated the basic architecture of the system as set forth in claim 21, whereas FIG. 6 illustrates the beginning of a sequence of method wherein tokens are transferred while holding the two communication devices 30, 31, each of which comprises a short range communication unit, close together.

“Short range communication” (or alternatively also referred to as “proximity communication”) refers to any kind of communication for which it is a prerequisite for communication that the two communication devices 30, 31 are physically brought into a relatively small distance—and optionally—that there is intervisibility between the two communication units and/or that a user manually brings those two units very close together, if necessary up to a point where there is actually a direct physical contact between the two communication devices. This is done to assure that no other communication device of a third party could be physically moved into a remaining gap between the two communication units 30, 31 and thus intercept the communication between the two communication units 30, 31.

The requirement for making use of the financial service in accordance with the method or system in accordance with the invention is that both the users 40, 41 as well as the financial services providers 43, 44 are memorized in the user data storage 15 and services provider data storage 16, respectively, and are registered with the electronic financial services exchanger 10.

The first user 40 in the role of the transferor selects on his communication device 30 the function “pay”.

The communication device 30 of the first user 40 with the aid of its comprised short range communication unit 32 starts to repetitively send token requests.

The second user 41 in the role of the transferee selects in step S2.1 on his communication device 31 the function “receive payment” and then enters in step S2.2 the necessary data (preferably amount of payment, currency, VAT included/not included).

In step S2.3 the electronic financial services exchanger 10 receives the order for payment handling and in the present embodiment of the method in step S2.4 generates a token 42 which is sent in step S2.5 to the communication device 31 of the second user 41.

Initiated by the received token 42 the short range communication unit 32 of the second user 41 waits in step S2.6 for a token request 42a which is sent by the short range communication unit 32 of the communication device 30 of the first user 40 while both communication devices 30, 31 are being put together in a close distance to each other.

When the token request 42a has been received by the short range communication unit 33 of the second user 41 in step D1 the token 42 will be sent in step S2.7 to the short range communication unit 32 of the first user 40 by the short range communication unit 33 of the second user 41.

Once the token 42 has been received by the short range communication unit 32 of the first user 40 in step S2.8 a token reception response 42b could, but does not have to be sent to the short range communication unit 33 of the second user 41 by the short range communication unit 32 of the first user 40.

After the transfer of the token 42 from the communication device 31 of the second user 41 to the communication device 30 of the first user 40 has been completed in step S2.9 the token 42 will be sent to the financial services exchanger 10 by the communication device 30 of the first user 40.

As soon as the token 42 from the communication device 30 of the first user 40 has been received by the financial services exchanger 10 the payment partners (first user 40 and second user 41) are fully known to the financial services exchanger 10 (milestone A).

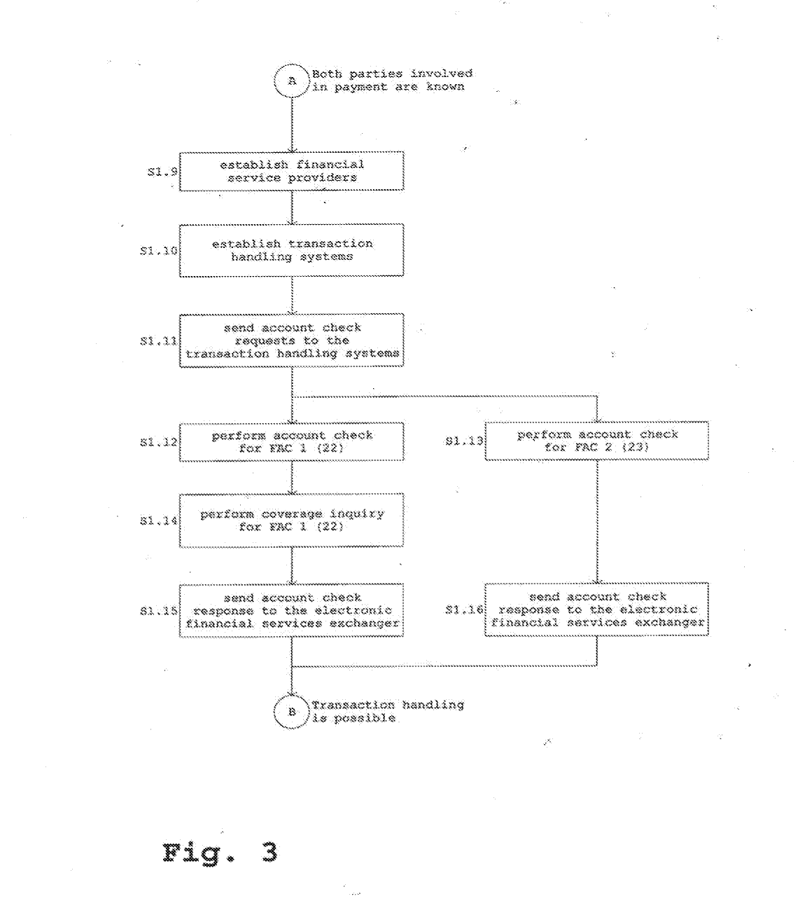

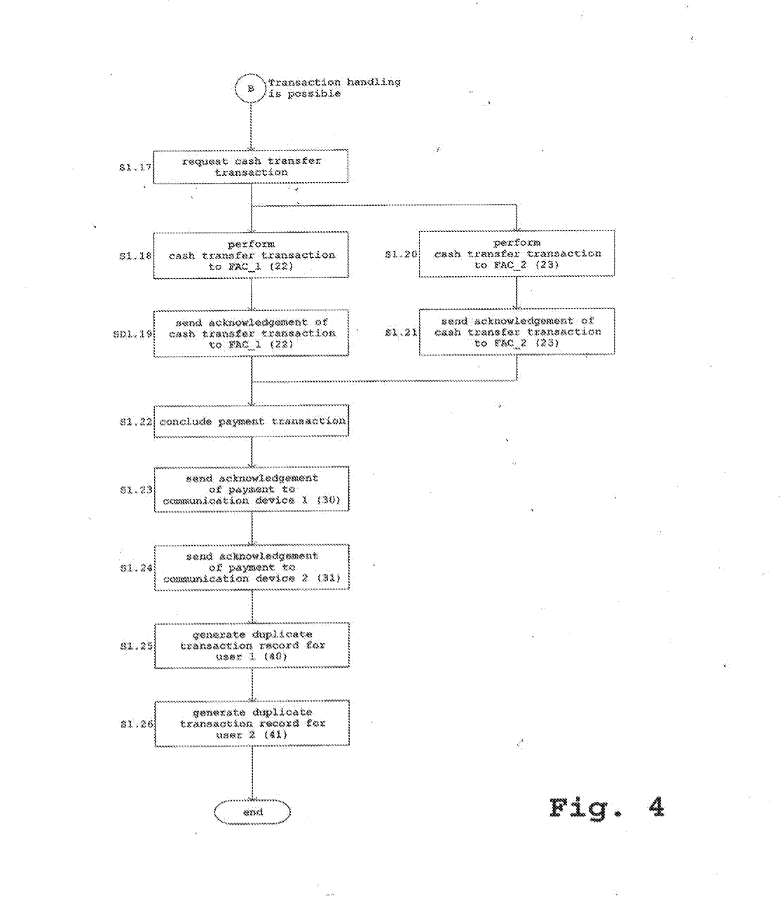

The further sequence of steps of the second method employed with the second system shown in FIG. 5 is fully identical to the sequence of steps employed in the first method as described above in conjunction with the steps between milestone A in FIG. 3 until the “end” of the sequence shown in FIG. 4.

### Third Example Embodiment

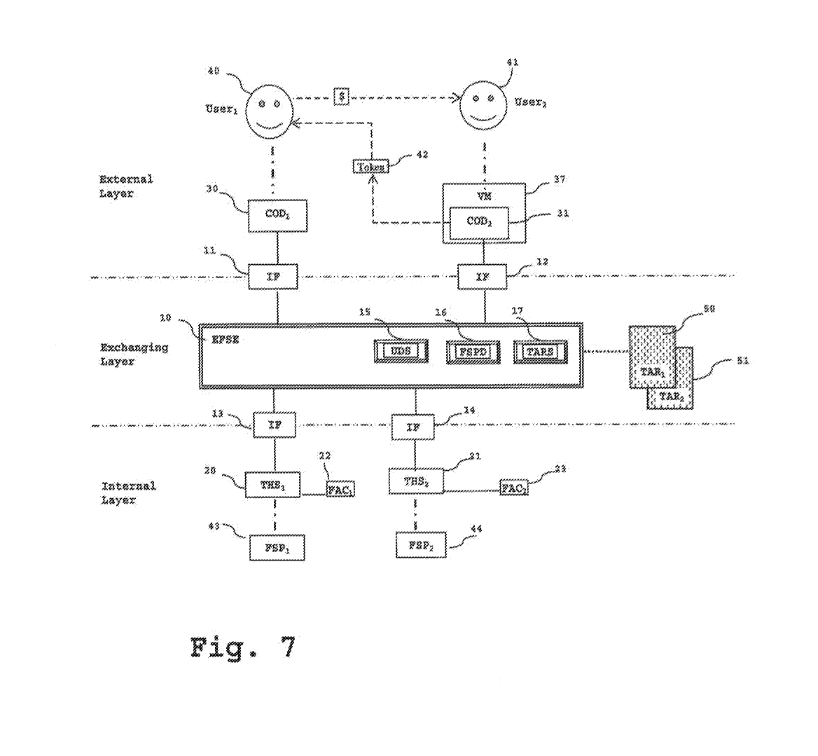

FIG. 7 shows a third embodiment of a system according to the invention based on the first embodiment shown in FIG. 1 but wherein the second communication device 31 is integrated into a vending machine 37.

The sequence of steps of a method which is employed on this third system shown in FIG. 7 is in principle the same as the sequence of steps shown in and discussed in connection with FIGS. 2 to 4.

A vending machine 37 has the capability to automatically grant access to an ordered product for the first user 4 0 once the payment transaction has been successfully handled.

Especially, an automated teller machine can be considered as a vending machine 37 with the capability to automatically grant access to an ordered certain amount of cash for the first user 40 once the payment transaction has been successfully handled.

The difference to the first method as explained in and discussed in connection with Figs, 1 to 4 is that the second user 41 does not communicate the token 42 to the first user 40. The token 42 is directly displayed by the vending machine instead.

The first user 40 reads the token from the display unit of the vending machine 37 and enters it, preferably, into his communication device 30.

The token 42 will be sent to the financial services exchanger 10 by the communication device 3 0 of the first user 40.

After the vending machine 37 has received the confirmation of payment the ordered product will be released by the vending machine 37 to the first user 40.

### Fourth Example Embodiment

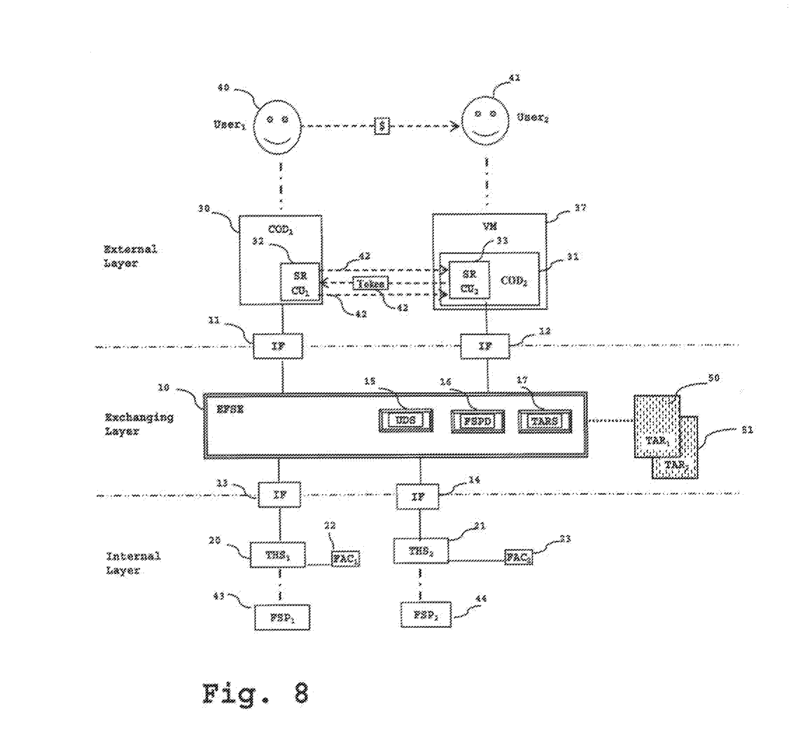

FIG. 8 shows a fourth embodiment of a system according to the invention based on the second embodiment shown in FIG. 5 but wherein the second communication device 31 comprising the second short range communication device 33, is integrated into a vending machine 37.

The sequence of steps of a method which is employed on this fourth system shown in FIG. 8 is in principle the same as the sequence of steps shown in and discussed in connection with FIG. 5.

A vending machine 37 is connected to the electronic financial services exchanger 10. The token 42 is transferred from the vending machine 37 or automatic teller machine (ATM) 38 to the communication device 30 of the first user 40 with the aid of the short range communication units 32, 33 each comprised in the communication device 3 2 of the first user 40 respectively the vending machine 37 or ATM 38.

After the first user 40 has ordered a product on the vending machine 37 all necessary data (preferably amount of payment, currency, tax such as sales tax or VAT included/not included) will be arranged by the vending machine 37 and sent to the financial services exchanger 10.

The financial services exchanger 10 generates a token 42 and communicates it to the vending machine 37.

The first short range communication unit 32 of the first user 40 receives the token from the second short range communication device 33 of the second user 41 while putting the first communication device 30 sufficiently close to the second communication device 31 integrated in the vending machine.

For this purpose it is preferable to have a visual marker displayed on the vending machine or being comprised thereon in a region which is sufficiently close to the second short range communication unit 32 of the second user in order to allow the reception of the token by the first short range communication unit 31 when the first communication device 30 is held sufficiently close to said visual marker.

After the vending machine 37 has received the confirmation of payment the ordered product will be released by the vending machine 37 to the first user 40.

### Fifth Example Embodiment

In the aforementioned exemplary embodiments it was implicitly assumed that both the registration of the users and the handling of transaction data for both the first user 40 in the role of a transferor and the second user 41 in the role of a transferee take place on the same hardware platform serving as electronic financial services exchanger 10.

However, there may be a desire on the side of either transferor 40 or transferee 41 to have his registration and/or the handling of his transactions take place on a dedicated hardware platform (“sub servers”) which is different from the platform on which the central electronic financial services exchanger 10 (“main server”) works, be it because the user wishes to have a direct control over his registration data or be it because the user wishes to assure a certain degree of data security on his own. In these cases at least one of the users (transferor 40 or transferee 41) may make use of a sub server which is under his actual/physical and/or legal control for the purposes of administering his registration data and/or handling transaction data.

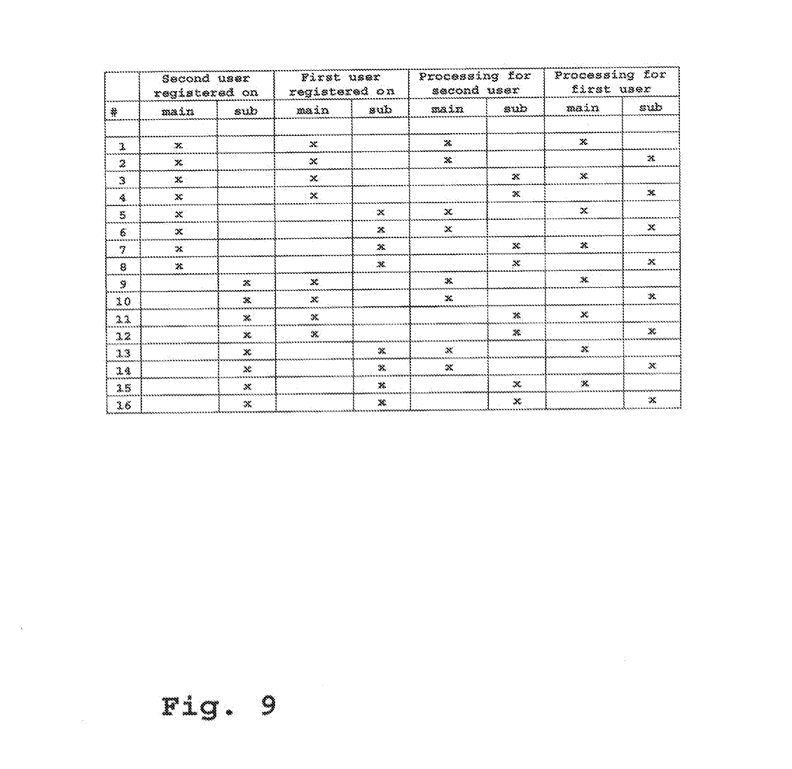

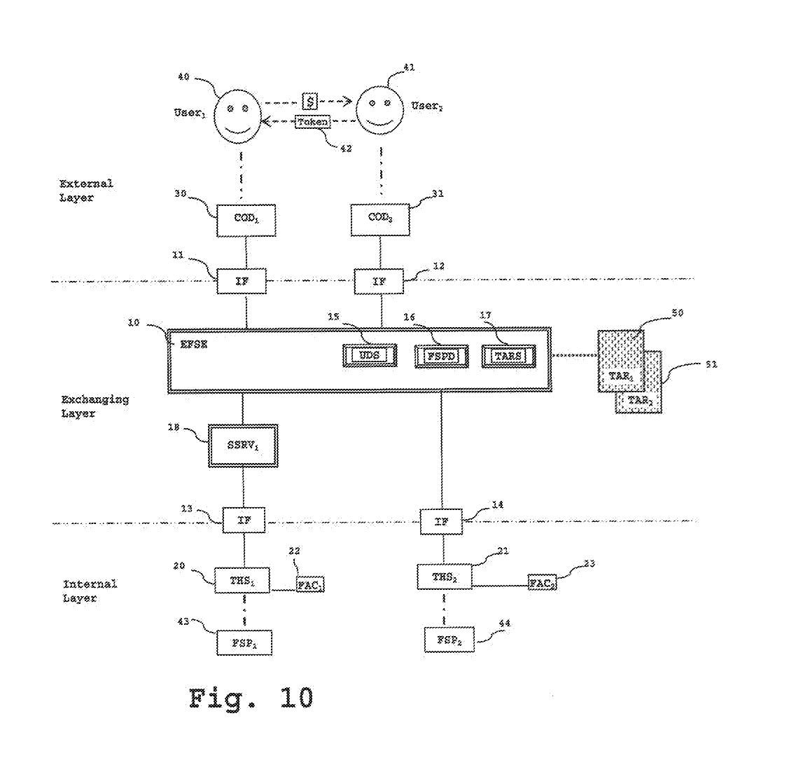

FIG. 9 shows an overview table which displays the combinatorial possibilities that arise in a situation where there is one transferor 40 and one transferee 41, each of which may or may not have either his registration data and/or his transaction data administered not a main server 10 but on a sub server 18 (FIG. 10).

In the first line in the overview table of FIG. 9 it is assumed that for both the second user and the first user both the registration and the handling of transaction data (“Processing)”) is taking place on a main server.

This is a standard scenario.

FIG. 10 schematically shows an arrangement of an electronic financial services exchanger 10, which shows an arrangement corresponding to the combination shown in line 6 of FIG. 9. Therein, the second user “transferee” is an “ordinary user” without any special preferential license status and he is subsequently registered on a common main server, which he shares with a multitude of other users. However, in this scenario, the first user “transferor” 40 enjoys a preferential license status and his registration data are administered on a special dedicated sub server 18. Additionally, the transferee's transaction data are also handled on the main server, whereas the transferor's transaction data enjoy preferential treatment on a dedicated sub processor.

### LIST OF REFERENCE NUMERALS

EFSE electronic financial services exchanger

IF interface for communication devices

IF interface for communication devices

IF interface for transaction handling systems

IF interface for transaction handling systems

UDS user data storage

FSPDS financial services provider data storage

TARS transaction record storage

SSRV1 EFSE sub server (first user)

THS1 first transaction handling system

THS2 second transaction handling system

FAC1 financial account (first user)

FAC 2 financial account (second user)

COD1 communication device (first user)

COD2 communication device (second user)

VM vending machine (second user)

ATM automated teller machine (second user)

SRCU1 short range communication unit (first user)

SRCU2 short range communication unit (second user)

token

42a token request

42b token reception response

User1 first user

User2 second user

FSP1 first financial services provider

FSP2 second financial services provider

TARI transaction record (first user)

TAR2 transaction record (second user)

1. A method for secure handling of electronic financial transactions between users by using a computer-implemented system, wherein secure handling of electronic financial services is effected by means of:
an electronic financial services exchanger,
a communication device associated with a first user in the role of the transaction initiator, connected by an interface to the electronic financial services exchanger,
a communication device associated with a second user in the role of the transaction handler, connected by an interface to the electronic financial services exchanger,
at least one financial account associated with a first user serviced by at least one financial services provider,
at least one financial account associated with a second user serviced by at least one financial services provider,
at least one transaction handling system associated with at least one financial services provider for accessing the financial accounts and of each of the users, respectively,
comprising the steps
assigning each user to the electronic financial services exchanger sing communication devices by the users entering a dedicated ID code and a secret code or other characteristic information of that user into communication devices for communication to the electronic financial services exchanger
authenticating the said users using the secret or characteristic information of users saved in the electronic financial services exchanger by the electronic financial services exchanger comparing the communicated assignment data of the users to the secret information saved in the electronic financial services exchanger,
initiating a financial service transaction by the transaction initiator,
entering the transaction parameters in a communication device by either party,
secure communication of the transaction parameters to the electronic financial services exchanger by said communication device,
allocating a token representing the initiated financial service transaction and the data thereof by the electronic financial services exchanger,
communicating the token to the communication device of the transaction initiator by the electronic financial services exchanger,
communicating the token from the transaction initiator to the other user,
accepting the token in the communication device of the other user,
communicating the token together with the user ID from the other user to the electronic financial services exchanger by a communication device,
establishing the financial services providers associated with the transaction partners by the electronic financial services exchanger,
requesting the transaction handling systems to handle the transaction by the electronic financial services exchanger,
handling the transaction by the transaction handling systems using the financial accounts of the users,
evaluating the response messages from the transaction handling systems of the users by the electronic financial services exchanger,
sending messages acknowledging handling of the transaction to the communication devices employed by the users by the electronic financial services exchanger.

2. The method according to claim 1, wherein
the electronic financial services exchanger comprises a data storage for records of the transaction in which the records associated with a transaction are stored for the users,
after sending messages confirming handling of the transaction the following steps are additionally involved:
generating a duplicate record of the transaction for the transaction initiator by the electronic financial services exchanger,
storing the duplicate record of the transaction by the transaction data storage,
generating a duplicate record of the transaction for the other user by the electronic financial services exchanger,
storing the duplicate record of the transaction by the transaction data storage.

3. The method according to claim 1, wherein said data storage may comprise hard drives, portable disks, semiconductor chips, holographic storages, magneto-optical memories, nanotubes, micro-electro-mechanical systems (MEMS), DNA storages.

4. The method according to claim 1, wherein
at least one of the communication devices used comprises means for sensing biometric or other characteristic data of one or more of the users and communicating same either untouched or compressed to the electronic financial services exchanger,
at least one user entering a dedicated ID code in said communication devices and each communicating their biometric data to said communication device,
authentication of at least one of the users is done using secret information of the user saved in the electronic financial services exchanger by the electronic financial services exchanger comparing the communicated assignment data of at least one of the users to the biometric data saved in the electronic financial services exchanger.

5. The method according to claim 1, wherein the registration of the first user and/or the second user and/or the handling of financial transactions for the first user and/or the second user takes place on dedicated hardware platforms which are different from the electronic financial services exchanger and for which the actual/physical and/or legal control lies in the hands of the first user and/or the second user, respectively.

6. A computer implemented system for performing one or more of the methods for secure handling of electronic financial transactions between users which comprises
an electronic financial services exchanger for central control of the complete method, comprising
a user data storage for storing the data of all registered users, the financial account data to the accounts of the said users,
a services provider data storage for storing the data of financial services providers including the access data to the transaction handling systems,
at least one communication device for use by a user and connected via an interface to the electronic financial services exchanger,
at least one financial account associated with a first user and serviced by the financial services provider,
at least one transaction handling system assigned to a financial services provider for performing electronic transactions, preferably electronic crediting, on the financial account of the user and connected via an interface to the electronic financial services exchanger,
at least one communication device for use by a second user and connected via an interface to the electronic financial services exchanger,
at least one financial account associated with the first user and serviced by a financial services provider,
at least one transaction handling system assigned to a financial services provider for performing electronic transactions, preferably electronic debiting on a financial account of the second user and connected via an interface to the electronic financial services exchanger.

7. The system according to claim 6, wherein at least one of the communication devices is a means of mobile telecommunication.

8. The system according to claim 6, wherein the electronic financial services exchanger comprises a data storage for records of the transaction in which records associated with a transaction are stored for the users.

9. The system according to claim 6, wherein sensors are provided for sensing data characteristic of the user, for example biometric, behavioral characteristic or physiological characteristic data of the users and communicating same either untouched or compressed to the electronic financial services exchanger.

10. The system according to claim 9, wherein sensors read any pertinent data such as biometric data such as fingerprints or retina or iris patterns or physiological data such as voice profiles.

11. The system according to claim 6, wherein each communication device comprises a short-range communication unit, respectively, for transferring tokens when holding the two communication devices close together.

12. The system according to claim 6, wherein the second communication device is integrated into a vending machine.

13. The system according to claim 12, wherein the vending machine directly displays the token.

14. The system according to claim 12, wherein the vending machine displays or comprises a visual marker in a region which is sufficiently close to the second short range communication unit in order to allow the reception of the token by the first short range communication unit (32) when the first communication device is held sufficiently close to the visual marker.

15. The system according to claim 6, wherein dedicated sub servers are provided for the registration of the first user and/or the second user and/or the handling of financial transactions for the first user and/or the second user, said sub servers being different from the electronic financial services exchanger and for which sub servers the actual and/or legal control lies in the hands of the first user and/or the second user, respectively.

16. A method for secure handling of electronic financial transactions between two users by using a computer-implemented system comprising the following steps of:
requesting a financial transaction by a first user in the role of a transferee via a first communication device which is connected to an electronic financial services exchanger system;
sending the transaction data together with identifying data of the transferee to said electronic financial services exchanger system;
opening a financial transaction for the transferee in the computer memory of said financial electronic financial services exchanger system with said transaction data;
storing said financial transaction to the transferee in a computer memory of the electronic financial services exchanger system;
generating a token for said transaction and storing it to said stored financial transaction;
sending said token to the first communication device of the transferee;
presenting said token by the transferee to any second user in the role of a potential transferor,
waiting of the transferee for fulfillment of said financial transaction
perceiving of said token by a second user in the role of the actual transferor;
requesting a fulfillment of said financial transaction by the transferor via a second communication device which is connected to the electronic financial services exchanger system;
receiving said token by said second communication device:
sending said token together with identifying data of the transferor to said electronic financial services exchanger system by said second communication device;
storing the identifying data of the actual transferor to said financial transaction in the financial services exchanger system;
selecting the financial account data of both the transferee and the transferor stored in the memory of the financial services exchanger system by the financial services exchanger system;
selecting the financial service provider belonging to financial account data of the transferor stored in the memory of the financial services exchanger system by the financial services exchanger system;
initiating a fund transfer transaction at the computer system of the financial service provider of the transferor which is connected to the financial services exchanger system via a interface by the financial services exchanger system;
transferring fund of said financial transaction from the financial account of the transferor to the financial account of the transferee by said computer system of the financial service provider of the transferor;
receiving a fund transfer transaction fulfillment message from the computer system of the financial service provider of the transferor by the financial services exchanger system;
sending a financial transaction fulfillment message to both the communication device of the transferee and the communication device of the transferor;
presenting a financial transaction fulfillment message to the transferee by the first communication device; and
presenting a financial transaction fulfillment message to the transferor by the second communication device.

17. The method as claimed in claim 16, wherein at least one of said first and second communication devices is a short range communication device.

18. The method as claimed in claim 17, wherein said first and second communication devices are capable of transferring said token from one to the other when held in close proximity.

19. The method as claimed in claim 16, wherein said token consists of a string of characters.

20. The method as claimed in claim 16, wherein said token is presented to any second user by one of the following:
(a) communicating said token to any second user in the role of a potential transferor,
(b) publishing said token,
(c) presenting said token by a display connected to the first communication device,
(d) presenting said token by short range wireless transfer.

21. The method as claimed in claim 16, wherein said receiving said token by said second communication device, is realized ether by:
(a) entering said token on the input device connected to said second communication device in the case of said token as a string of characters,
(b) receiving said token by a camera connected to said second communication device.

22. The method according to claim 16, wherein presentation of the token to a second user as a transferor is effected by a vending machine configured to receive and directly display the token.

23. The method according to claim 22, wherein the first communication device comprises a first short-range communication unit and the second communication device comprises a second short-range communication unit in order to transfer the token.

24. The method according to claim 23, wherein the vending machine displays or comprises a visual marker in a region which is sufficiently close to the second short range communication unit in order to allow the reception of the token by the first short range communication unit when the first communication device is held sufficiently close to the visual marker.
